(19) United States
(12) Patent Application Publication
(10) Pub. No.: US 2021/0287298 A1
(43) Pub. Date: Sep. 16, 2021

(54) ACTUARIAL PROCESSING METHOD AND DEVICE

(71) Applicant: PING AN TECHNOLOGY (SHENZHEN) CO., LTD., Shenzhen, Guangdong (CN)

(72) Inventors: Yongfan LIU, Shenzhen (CN); Zhi LI, Shenzhen (CN)

(21) Appl. No.: 16/321,809

(22) PCT Filed: Jan. 31, 2018
(86) PCT No.: PCT/CN2018/074863

§ 371 Date: Jan. 29, 2019

(30) Foreign Application Priority Data
Apr. 6, 2017 (CN) 201710221077.5

(51) Int. Cl. G06Q 40/08; G06F 16/242; H04L 9/06

(52) U.S. Cl. CPC G06Q 40/08; H04L 9/0643; G06F 16/244

(57) ABSTRACT

An embodiment of the present application discloses an actuarial processing method for solving the problems that the actuarial processing takes a long time and the processing efficiency is low. The method according to the embodiment of the present application includes determining target policy data to be actuarially processed; grouping the target policy data according to a preset product grouping rule to obtain each data group; extracting data dimensions in the data group that meet preset conditions; splicing data values belonging to the same data dimension in the data group to obtain a spliced string; encrypting the obtained spliced string to obtain a dimension identifier corresponding to the data dimension in the data group; grouping the target policy data under the data group according to the dimension identifier corresponding to each of the data dimensions extracted from the data group, to obtain each data subgroup to be actuarially processed under the data group; and performing actuarial processing respectively on each of the data subgroups to be actuarially processed by a preset actuarial program. An embodiment of the present application also provides an actuarial processing device.

The present application claims priority of Chinese Patent Application No. 201710221077.5, entitled “ACTUARIAL PROCESSING METHOD AND DEVICE”, filed on Apr. 6, 2017, the entire contents of which are incorporated herein by reference.

### TECHNICAL FIELD

The present application relates to the field of financial services, and in particular, to an actuarial processing method and device.

### BACKGROUND

In the insurance industry, data actuarial is an important means of data forecasting and statistics.

For example, for insurance companies, the calculation of claim reserves is a very important link of risk management. Most insurance companies calculate the claim reserves at set intervals (such as once every half a month) to ensure that when claims are settled, a claim payment can be completed on time. Currently, the calculation of claim reserves is generally carried out through actuarial software, such as PROPHET model-based actuarial programs.

However, since the calculation of the claim reserves involves all valid policies of an insurance company, the data volume of these policies is extremely large, but an actuarial program is carried out for each independent policy when calculating the claim reserves. Although the calculation of claims for a policy does not take much time, when the base of the valid policies is huge, it often takes a lot of time to calculate the claim reserve of an insurance company each time, which greatly increases the calculation cost of the claim reserve of the insurance company.

### TECHNICAL PROBLEM

An embodiment of the present application provides an actuarial processing method and device, which can reduce the workload of the actuarial program repeatedly processing the same data dimension value, and improve the efficiency of the actuarial processing.

### TECHNICAL SOLUTION

A first aspect provides an actuarial processing method which includes:

determining target policy data to be actuarially processed;

grouping the target policy data according to a preset product grouping rule to obtain each data group;

extracting data dimensions in the data group that meet preset conditions;

splicing data values belonging to the same data dimension in the data group to obtain a spliced string;

encrypting the obtained spliced string to obtain a dimension identifier corresponding to the data dimension in the data group;

grouping the target policy data under the data group according to the dimension identifier corresponding to each of the data dimensions extracted from the data group, to obtain each data subgroup to be actuarially processed under the data group; and

respectively performing actuarial processing on each of the data subgroups to be actuarially processed by a preset actuarial program.

### BENEFICIAL EFFECT

As can be seen from the above technical solutions, an embodiment of the present application has the following advantages:

In the embodiment of the present application, first, target policy data to be actuarially processed is determined; then, the target policy data is grouped according to a preset product grouping rule to obtain each data group; data dimensions that meet preset conditions are extracted in the data group; data values belonging to the same data dimension in the data group are spliced to obtain a spliced string; the obtained spliced string is encrypted to obtain a dimension identifier corresponding to the data dimension in the data group; the target policy data under the data group is grouped according to the dimension identifier corresponding to each of the data dimensions extracted in the data group, and each data subgroup to be actuarially processed under the data group is obtained; and finally actuarial processing is performed respectively on each of the data subgroups to be actuarially processed by a preset actuarial program. In the embodiment of the present application, under the same product grouping, the target policy data with the same data dimension are divided into a data subgroup to be actuarially processed according to the dimension identifier; and the actuarial program is used to perform actuarial processing on these data subgroups to be actuarially processed, so that the workload of the actuarial program repeatedly processing the same data dimension value is reduced, and the efficiency of the actuarial processing is improved; in the scenario of calculating the claim reserve, the time cost of the calculation is effectively reduced, and the calculation cost of an insurance company is saved.

### BRIEF DESCRIPTION OF DRAWINGS

FIG. 1 is a flow chart of an embodiment of an actuarial processing method according to the present application;

FIG. 2 is a schematic flow chart of step 104 of an actuarial processing method in an application scenario according to the present application;

FIG. 3 is a schematic flow chart of grouping error handling of an actuarial processing method in an application scenario according to the present application;

FIG. 4 is a structure diagram of Embodiment 1 of an actuarial processing device according to the present application;

FIG. 5 is a structure diagram of Embodiment 2 of an actuarial processing device according to the present application; and

FIG. 6 is a structure diagram of Embodiment 3 of an actuarial processing device according to the present application.

### DETAILED DESCRIPTION OF EMBODIMENTS

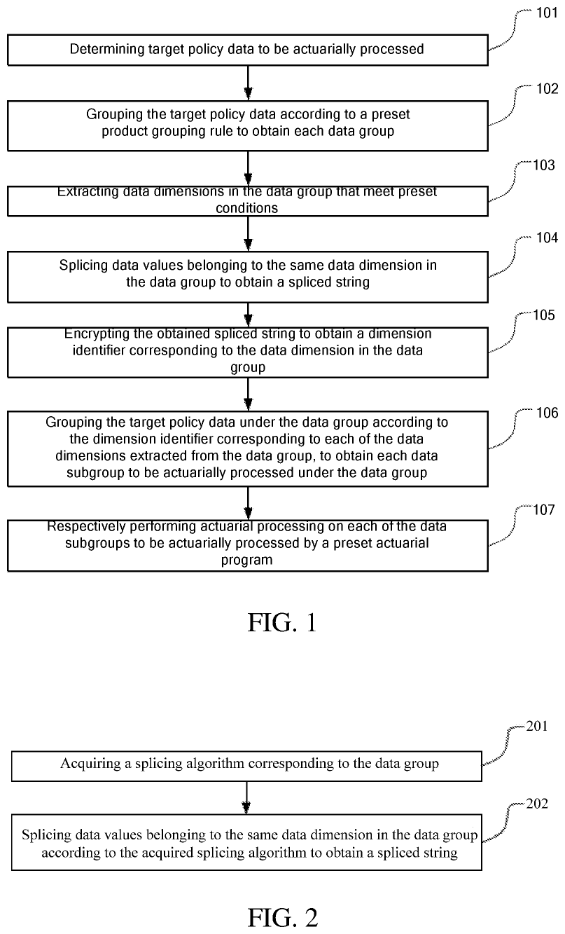

Referring to FIG. 1, an embodiment of an actuarial processing method according to the present application includes:

Step 101: determining target policy data to be actuarially processed.

In this embodiment, for different actuarial tasks, the determined data to be actuarially processed are different. For example, if the task of the actuarial processing this time is the actuarial calculation of an insurance company's claim reserve, then all the existing valid policies of the insurance company can be determined as target policy data to be actuarially processed. In describing the actuarial processing method of this embodiment, for convenience of description, the following content is mainly explained based on the actuarial processing of the claim reserve as an example. It should be understood that the actuarial processing method provided by the present application can also be applied to other actuarial tasks, which will not be described again in this embodiment.

Understandably, since most insurance companies currently use different servers for the division and storage for managed policy data, it is likely that for the target policy data of an actuarial task, the target policy data are not located on the same server or database. At this time, the target policy data can be captured from multiple servers or databases of this insurance company by means of data statistics, and the target policy data are aggregated in a server or database to facilitate the subsequent actuarial processing of an actuarial program. Specifically, the model point summary (model point summary) can be used to synchronize policies and other business data from multiple databases to a database PALA specified by the actuarial program, and then based on the policy data, insured amounts, premiums, and cash values are collected to an entry of policy record according to the relationship between main risks and additional risks, to prepare basic data for the subsequent calculation of the claim reserve.

Further, after data summarization of the policy data, in order to enable the target policy data to be identified and processed by the actuarial program, data cleaning of the target policy data may be performed in advance. For example, a certain entry of target policy data includes “type of insurance: life insurance, claim amount: 500W”, where “life insurance” is the value of the “type of insurance” attribute in the policy data. As “life insurance” is not a digit or character that is beneficial to the actuarial process, the “life insurance” can be converted, for example, if “K001” is used instead, the data cleaning of the policy data “type of insurance” attribute is completed. It can be understood that the value of a data format to which the target policy data are converted during data cleaning is generally determined by the actuarial program used in subsequent steps.

Step 102: grouping the target policy data according to a preset product grouping rule to obtain each data group.

For the determined target policy data, the policy data are generally closely related to the type of insurance products, and the corresponding policy data generated by different insurance products differs greatly. For example, life insurance, auto insurance, medical insurance and other insurance products have significant differences in information or data of policies generated these insurance products, such as the amount of claims, premiums, claim liabilities. Therefore, in this embodiment, the product grouping rule can be set in advance, and when the target policy data are grouped, the product grouping rule is used to distinguish the target policy data generated by the insurance products with data forms differing greatly, and divide the target policy data into different data groups, to facilitate data dimension extraction and actuarial processing in subsequent steps.

In particular, since product names of different insurance products are also different, the target policy data belonging to different insurance products can be distinguished by the product names Therefore, further, the above step 102 may include grouping the target policy data according to the product names which the target policy data belongs to, to obtain each data group.

Step 103: extracting, in the data group, data dimensions that meet preset conditions.

After the target policy data are divided into data groups, it can be known from the above that the target policy data in the same data group belongs to those of the same or similar insurance products, and the target policy data often has the same data dimension. For example, in the data group corresponding to medical insurance, each target policy data generally includes the amount of claims, premiums, various medical claim liabilities, insurance validity periods, additional risks, etc., and the values of these data dimensions are all the same or similar within a certain range, so these data dimensions can be extracted from this data group.

In this embodiment, for a preset product grouping rule, preset conditions corresponding to each data group after grouping may be respectively set to extract data dimensions of the corresponding data group. It can be understood that for the data group of the same insurance product, it has one or more identical data dimensions, such as types of insurance, payment period, gender, age, payment type, insurance period, etc., so for a data group for different insurance products, the data dimensions which need to be extracted as “preset conditions” of the data group can be preset well, and during extraction, corresponding data dimensions can be directly extracted from the target policy data of the data group.

Step 104: splicing data values belonging to the same data dimension in the data group to obtain a spliced string.

In this embodiment, after each data dimension in the data group is extracted, splicing processing may be performed on data values of the same data dimension, thereby generating the spliced string. There are multiple splicing algorithms that can be used for splicing data values, such as averaging, weighted averaging, summation, etc.

In order to reduce the loss of the data precision when the data values of the same data dimension are spliced, different splicing algorithms may be preset for different data groups. Specifically, before step 104, the corresponding splicing algorithm is configured for each of the data groups, and the splicing algorithms corresponding to the data groups are different from each other. It can be understood that, if different splicing algorithms are configured for different data groups, after the data dimensions of the data groups are extracted, the possibility of the same strings obtained by splicing is greatly reduced.

As is known from the description of the foregoing step 103, each data group has a corresponding relationship with the product name. Therefore, the step of configuring the corresponding splicing algorithm for each of the data groups may specifically include respectively configuring a corresponding splicing algorithm for each of the data groups according to the product name corresponding to the data group and a preset algorithm configuration table, where the algorithm configuration table has a corresponding relationship between the product name and a preset splicing algorithm recorded thereon. By recording the corresponding relationship between the product name and the splicing algorithm in the algorithm configuration table in advance, when the corresponding splicing algorithm needs to be configured for each data group, the corresponding splicing algorithm can be quickly matched out from the algorithm configuration table, which greatly improves the matching efficiency of the data group and the splicing algorithm.

Therefore, further, before the splicing processing of the data value, the splicing algorithm may be acquired. As shown in FIG. 2, the foregoing step 104 may include:

Step 201: acquiring a splicing algorithm corresponding to the data group; and

Step 202: splicing data values belonging to the same data dimension in the data group according to the acquired splicing algorithm to obtain a spliced string.

For the above steps 201 and 202, it is assumed that the acquired splicing algorithm corresponding to one data group is an averaging algorithm. The data dimension in the data group is “insurance period”, and the data values belonging to the “insurance period” dimension in three entries of target policy data of the data group are 20130516−20180516 (i.e., May 16, 2013 to May 16, 2018; the following values are similar and are no longer explained), 20140213−20200213, 20160917−20220917, these three data values are averaged, namely (20130516+20140213+20160917)/3−(20180516+20200213+20220917)/3, equal to 20143882−20200549 (rounded). Thus, the obtained spliced string is 20143882−20200549.

Step 105: encrypting the obtained spliced string to obtain a dimension identifier corresponding to the data dimension in the data group.

In this embodiment, specifically, the spliced string can be encrypted into a 32-bit string by using an MD5 encryption mode, and the encrypted string is the dimension identifier corresponding to the data dimension, namely the dimension ID.

Step 106: grouping the target policy data under the data group according to the dimension identifier corresponding to each of the data dimensions extracted from the data group, to obtain each data subgroup to be actuarially processed under the data group.

After the dimension identifier of each data dimension in the data group is obtained, the target policy data in the data group can be further grouped to obtain each data subgroups to be actuarially processed. It can be seen that each entry of target policy data in the same data subgroup to be actuarially processed has the same dimension identifier.

In this embodiment, it is known from the content described in the above step 101 that after the target policy data to be actuarially processed is determined, the target policy data may be subjected to data cleaning processing. After the data are cleaned, the target policy data after the data cleaning processing may be respectively stored to each preset data storage path according to preset storage requirements. Based on this, the foregoing step 106 may include:

grouping the target policy data under the data group according to the dimension identifier corresponding to each of the data dimensions extracted in the data group and each of the data storage paths, to obtain each data subgroup to be actuarially processed under the data group.

It can be understood that, because services have different requirements for different policy data, by storing the target policy data after the data cleaning to respective data storage paths, it is more convenient for a salesperson to query the target policy data according to different needs. For example, on a path named “NB”, only new policy data generated this year are stored; and the path named “kaohe” is used to distinguish policy data from different databases. In the above step 106, specifically, the data storage paths are further added as a grouping basis, so that each data subgroup to be actuarially processed that is obtained after the grouping can be further refined, and it is avoided that the target policy data originally stored on different data storage paths are divided into one data subgroup to be actuarially processed, thereby ensuring the processing efficiency of the actuarial program to a certain extent.

Furthermore, it is also possible to comprehensively consider the evaluation time point of the target policy data, the name of type of insurance, and the like as the basis of the grouping. For example, the aforementioned step 106 may include grouping the target policy data under the data group according to the dimension identifier corresponding to each of the data dimensions extracted in the data group, the data storage paths of the target policy data, the evaluation time point and the name of type of insurance, to obtain each data subgroup to be actuarially processed under the data group.

In this case, the evaluation time point of the target policy data refers to the running time (an agreed time) of an AIO program.

The name of type of insurance of the target policy data refers to the name of type of insurance of the entry of policy data. In particular, different types of insurance can be modeled differently before the names of types of insurance are provided to the actuarial program.

Step 107: respectively performing actuarial processing on each of the data subgroups to be actuarially processed by a preset actuarial program.

In this embodiment, after each data subgroup to be actuarially processed is obtained by grouping, the actuarial processing may be performed on each of the data subgroups to be actuarially processed by a preset actuarial program, and the actuarial program may be prophet software or other actuarial software. This embodiment does not limit this.

It can be understood that since the target policy data in each data subgroups to be actuarially processed has the data values of the same data dimension, it is not necessary to repeatedly actuarially process these data values when the data values are actuarially processed by the actuarial program.

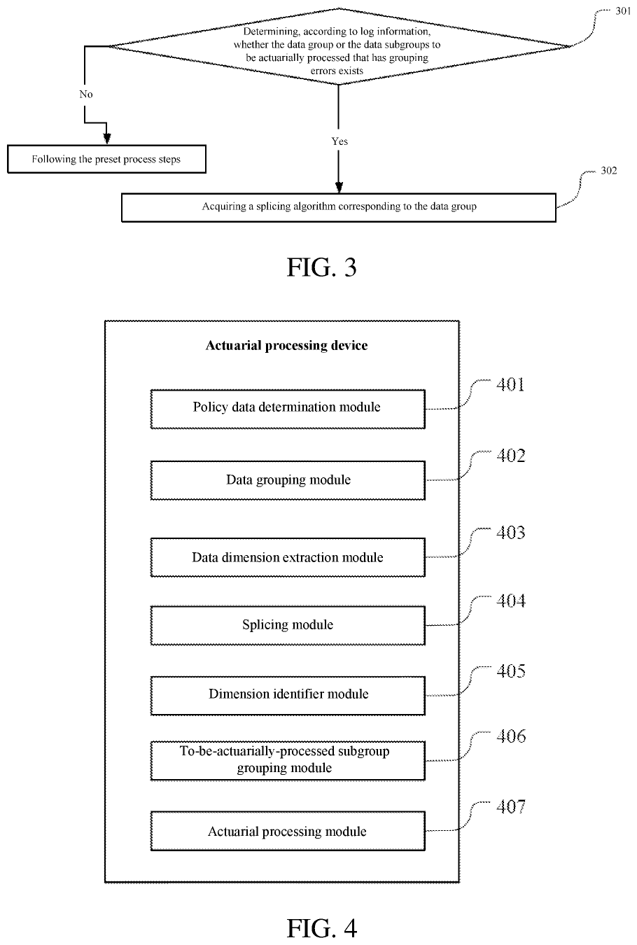

Further, as shown in FIG. 3, the actuarial processing method of this embodiment may further include:

Step 301: determining, according to log information, whether the data group or the data subgroups to be actuarially processed that has grouping errors exists, and if yes, executing step 302; and if not, performing processing according to a preset process step;

Step 302: returning to execute the step of grouping the target policy data according to a preset product grouping rule to obtain each data group again.

For the above steps 301 and 302, it can be understood that when a grouping error is found, the process may return to execute the above step 102 again, and the method of this embodiment is re-executed for grouping processing and actuarial processing. In an application scenario, the repeated execution of the actuarial processing method of this embodiment is supported, to ensure the data accuracy of the actuarial task processing performed this time.

In this embodiment, under the same product grouping, the target policy data with the same data dimension are divided into a data subgroup to be actuarially processed according to the dimension identifier; and the actuarial program is used to perform actuarial processing on these data subgroups to be actuarially processed, so that the workload of the actuarial program repeatedly processing the same data dimension value is reduced, and the efficiency of the actuarial processing is improved; in the scenario of calculating the claim reserve, the time cost of the calculation is effectively reduced, and the calculation cost of an insurance company is saved.

FIG. 4 illustrates a structure diagram of Embodiment 1 of an actuarial processing device according to an embodiment of the present application.

As shown in FIG. 4, in this embodiment, an actuarial processing device includes:

a policy data determination module 401, configured to determine target policy data to be actuarially processed;

a data grouping module 402, configured to group the target policy data according to a preset product grouping rule to obtain each data group;

a data dimension extraction module 403, configured to extract data dimensions in the data group that meet preset conditions;

a splicing module 404, configured to splice data values belonging to the same data dimension in the data group to obtain a spliced string;

a dimension identifier module 405, configured to encrypt the obtained spliced string to obtain a dimension identifier corresponding to the data dimension in the data group;

a to-be-actuarially-processed subgroup grouping module 406, configured to group the target policy data under the data group according to the dimension identifier corresponding to each of the data dimensions extracted from the data group, to obtain each data subgroup to be actuarially processed under the data group; and

an actuarial processing module 407, configured to respectively perform actuarial processing on each of the data subgroups to be actuarially processed by a preset actuarial program.

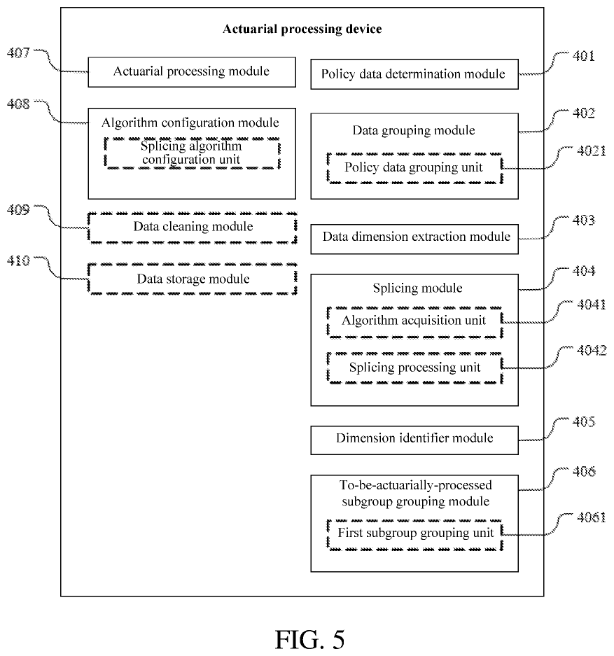

FIG. 5 illustrates a structure diagram of Embodiment 2 of an actuarial processing device according to an embodiment of the present application.

As shown in FIG. 5, further, the actuarial processing device may also include:

an algorithm configuration module 408, configured to respectively configure a corresponding splicing algorithm for each of the data groups, where the splicing algorithms corresponding to the data groups are different from each other;

the splicing module 404 includes:

an algorithm acquisition unit 4041, configured to acquire a splicing algorithm corresponding to the data group; and

a splicing processing unit 4042, configured to splice data values belonging to the same data dimension in the data group according to the acquired splicing algorithm to obtain a spliced string.

Further, the data grouping module 402 may include:

a policy data grouping unit 4021, configured to group the target policy data according to product names which the target policy data belongs to, to obtain each data group;

the algorithm configuration module 408 includes:

a splicing algorithm configuration unit 4081, configured to respectively configure a corresponding splicing algorithm for each of the data groups according to a product name corresponding to each of the data groups and a preset algorithm configuration table, where the algorithm configuration table has a corresponding relationship between the product name and a preset splicing algorithm recorded thereon.

Further, the actuarial processing device may also include:

a data cleaning module 409, configured to perform data cleaning processing on the target policy data;

a data storage module 410, configured to respectively store the target policy data after the data cleaning processing to each of preset data storage paths according to preset storage requirements.

The to-be-actuarially-processed subgroup grouping module 406 includes:

a first subgroup grouping unit 4061, configured to group the target policy data under the data group according to the dimension identifier corresponding to each of the data dimensions extracted in the data group and each of the data storage paths, to obtain each data subgroup to be actuarially processed under the data group.

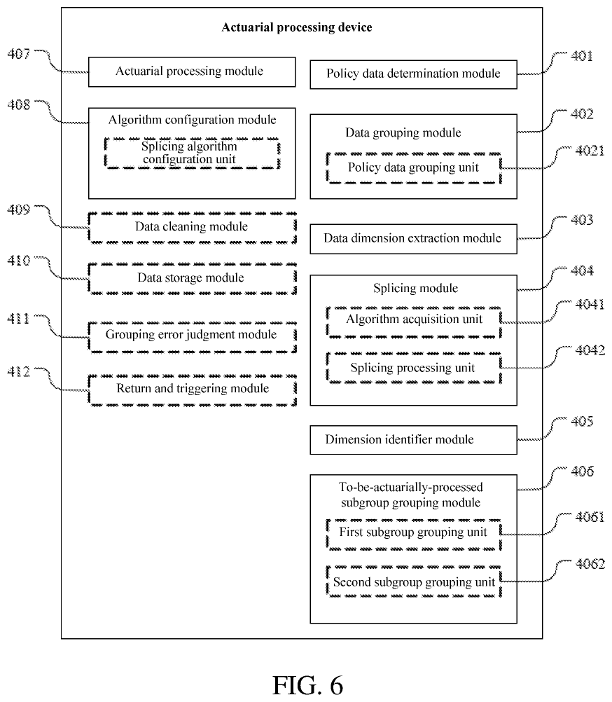

FIG. 6 illustrates a structure diagram of Embodiment 3 of an actuarial processing device according to an embodiment of the present application.

As shown in FIG. 6, further, the to-be-actuarially-processed subgroup grouping module 406 may include:

a second subgroup grouping unit 4062, configured to group the target policy data under the data group according to the dimension identifier corresponding to each of the data dimensions extracted in the data group, the data storage paths of the target policy data, an evaluation time point and a name of type of insurance, to obtain each data subgroup to be actuarially processed under the data group.

Further, the actuarial processing method may also include:

a grouping error judgment module 411, configured to determine, according to log information, whether the data group or the data subgroups to be actuarially processed that has grouping errors exists; and

a return and triggering module 412, configured to return to trigger the data grouping module 402 if the determination result of the grouping error judgment module is yes.

The above embodiments are only used to illustrate the technical solutions of the present application, and are not intended to limit the technical solutions; although the present application has been described in detail with reference to the foregoing embodiments, those of ordinary skills in the art should understand that they can still modify the technical solutions recorded in each aforementioned embodiment, or perform equivalent substitutions on some of the technical features therein; and such modifications or substitutions do not make the essence of the corresponding technical solution depart from the spirit and scope of the technical solution of each embodiment of the present application.

1. An actuarial processing method, comprising:
determining target policy data to be actuarially processed;
grouping the target policy data according to a preset product grouping rule to obtain each data group;
extracting data dimensions in the data group that meet preset conditions;
splicing data values belonging to the same data dimension in the data group to obtain a spliced string;
encrypting the obtained spliced string to obtain a dimension identifier corresponding to the data dimension in the data group;
grouping the target policy data under the data group according to the dimension identifier corresponding to each of the data dimensions extracted from the data group, to obtain each data subgroup to be actuarially processed under the data group; and
respectively performing actuarial processing on each of the data subgroups to be actuarially processed by a preset actuarial program.

2. The actuarial processing method according to claim 1, wherein before the step of splicing data values belonging to the same data dimension in the data group according to the acquired splicing algorithm to obtain a spliced string, wherein the method further comprises:
respectively configuring a corresponding splicing algorithm for each of the data groups, wherein the splicing algorithms corresponding to the data groups are different from each other;
and wherein the step of splicing data values belonging to the same data dimension in the data group to obtain a spliced string comprises:
acquiring a splicing algorithm corresponding to the data group; and
splicing data values belonging to the same data dimension in the data group according to the acquired splicing algorithm to obtain a spliced string.

3. The actuarial processing method according to claim 2, wherein the step of grouping the target policy data according to a preset product grouping rule to obtain each data group comprises:
grouping the target policy data according to product names which the target policy data belongs to, to obtain each data group;
wherein the step of respectively configuring a corresponding splicing algorithm for each of the data groups comprises:
respectively configuring a corresponding splicing algorithm for each of the data groups according to a product name corresponding to each of the data groups and a preset algorithm configuration table, wherein the algorithm configuration table records a corresponding relationship between the product name and a preset splicing algorithm.

4. The actuarial processing method according to claim 1, wherein after the step of determining target policy data to be actuarially processed, the method further comprises:
performing data cleaning processing on the target policy data;
respectively storing the target policy data after the data cleaning processing to each preset data storage path according to preset storage requirements;
wherein the step of grouping the target policy data under the data group according to the dimension identifier corresponding to each of the data dimensions extracted from the data group, to obtain each data subgroup to be actuarially processed under the data group comprises:
grouping the target policy data under the data group according to the dimension identifier corresponding to each of the data dimensions extracted in the data group and each of the data storage paths, to obtain each data subgroup to be actuarially processed under the data group.

5. The actuarial processing method according to claim 1, wherein the step of grouping the target policy data under the data group according to the dimension identifier corresponding to each of the data dimensions extracted from the data group, to obtain each data subgroup to be actuarially processed under the data group comprises:
grouping the target policy data under the data group according to the dimension identifier corresponding to each of the data dimensions extracted in the data group, the data storage paths of the target policy data, an evaluation time point and a name of type of insurance, to obtain each data subgroup to be actuarially processed under the data group.

6. The actuarial processing method according claim 1, wherein the actuarial processing method further comprises:
determining, according to log information, whether the data group or the data subgroups to be actuarially processed that has grouping errors exists; and
returning to execute again the step of grouping the target policy data according to a preset product grouping rule to obtain each data group, if the data group or the data subgroups to be actuarially processed that has grouping errors exists.

7-10. (canceled)

11. A terminal device, comprising: a memory, a processor, and a computer readable instruction stored in the memory and executable on the processor, wherein when the processor executes the computer readable instruction, the following steps are implemented:
determining target policy data to be actuarially processed;
grouping the target policy data according to a preset product grouping rule to obtain each data group;
extracting data dimensions in the data group that meet preset conditions;
splicing data values belonging to the same data dimension in the data group to obtain a spliced string;
encrypting the obtained spliced string to obtain a dimension identifier corresponding to the data dimension in the data group;
grouping the target policy data under the data group according to the dimension identifier corresponding to each of the data dimensions extracted from the data group, to obtain each data subgroup to be actuarially processed under the data group; and
respectively performing actuarial processing on each of the data subgroups to be actuarially processed by a preset actuarial program.

12. The terminal device according to claim 11, wherein before the step of splicing data values belonging to the same data dimension in the data group according to the acquired splicing algorithm to obtain a spliced string, the method further comprises:
respectively configuring a corresponding splicing algorithm for each of the data groups, wherein the splicing algorithms corresponding to the data groups are different from each other;
wherein the step of splicing data values belonging to the same data dimension in the data group to obtain a spliced string comprises:
acquiring a splicing algorithm corresponding to the data group; and
splicing data values belonging to the same data dimension in the data group according to the acquired splicing algorithm to obtain a spliced string.

13. The terminal device according to claim 12, wherein the step of grouping the target policy data according to a preset product grouping rule to obtain each data group comprises:
grouping the target policy data according to product names which the target policy data belongs to, to obtain each data group;
wherein the step of respectively configuring a corresponding splicing algorithm for each of the data groups comprises:
respectively configuring a corresponding splicing algorithm for each of the data groups according to a product name corresponding to each of the data groups and a preset algorithm configuration table, wherein the algorithm configuration table records a corresponding relationship between the product name and a preset splicing algorithm.

14. The terminal device according to claim 11, wherein after the step of determining target policy data to be actuarially processed, the method further comprises:
performing data cleaning processing on the target policy data;
respectively storing the target policy data after the data cleaning processing to each preset data storage path according to preset storage requirements;
wherein the step of grouping the target policy data under the data group according to the dimension identifier corresponding to each of the data dimensions extracted from the data group, to obtain each data subgroup to be actuarially processed under the data group comprises:
grouping the target policy data under the data group according to the dimension identifier corresponding to each of the data dimensions extracted in the data group and each of the data storage paths, to obtain each data subgroup to be actuarially processed under the data group.

15. The terminal device according to claim 11, wherein when the processor executes the computer readable instruction, the following steps are further implemented:
determining, according to log information, whether the data group or the data subgroups to be actuarially processed that has grouping errors exists; and
if the data group or the data subgroups to be actuarially processed that has grouping errors exists, returning to execute again the step of grouping the target policy data according to a preset product grouping rule to obtain each data group.

16. A computer readable storage medium configured to store a computer readable instruction, wherein when the computer readable instruction is executed by a processor, the following steps are implemented:
determining target policy data to be actuarially processed;
grouping the target policy data according to a preset product grouping rule to obtain each data group;
extracting data dimensions in the data group that meet preset conditions;
splicing data values belonging to the same data dimension in the data group to obtain a spliced string;
encrypting the obtained spliced string to obtain a dimension identifier corresponding to the data dimension in the data group;
grouping the target policy data under the data group according to the dimension identifier corresponding to each of the data dimensions extracted from the data group, to obtain each data subgroup to be actuarially processed under the data group; and
respectively performing actuarial processing on each of the data subgroups to be actuarially processed by a preset actuarial program.

17. The computer readable storage medium according to claim 16, wherein before the step of splicing data values belonging to the same data dimension in the data group according to the acquired splicing algorithm to obtain a spliced string, the method further comprises:
respectively configuring a corresponding splicing algorithm for each of the data groups, wherein the splicing algorithms corresponding to the data groups are different from each other;
wherein the step of splicing data values belonging to the same data dimension in the data group to obtain a spliced string comprises:
acquiring a splicing algorithm corresponding to the data group; and
splicing data values belonging to the same data dimension in the data group according to the acquired splicing algorithm to obtain a spliced string.

18. The computer readable storage medium according to claim 17, wherein the step of grouping the target policy data according to a preset product grouping rule to obtain each data group comprises:
grouping the target policy data according to product names which the target policy data belongs to, to obtain each data group;
wherein the step of respectively configuring a corresponding splicing algorithm for each of the data groups comprises:
respectively configuring a corresponding splicing algorithm for each of the data groups according to a product name corresponding to each of the data groups and a preset algorithm configuration table, wherein the algorithm configuration table records a corresponding relationship between the product name and a preset splicing algorithm.

19. The computer readable storage medium according to claim 16, wherein after the step of determining target policy data to be actuarially processed, the method further comprises:
performing data cleaning processing on the target policy data;
respectively storing the target policy data after the data cleaning processing to each preset data storage path according to preset storage requirements;
wherein the step of grouping the target policy data under the data group according to the dimension identifier corresponding to each of the data dimensions extracted from the data group, to obtain each data subgroup to be actuarially processed under the data group comprises:
grouping the target policy data under the data group according to the dimension identifier corresponding to each of the data dimensions extracted in the data group and each of the data storage paths, to obtain each data subgroup to be actuarially processed under the data group.

20. The computer readable storage medium according to claim 16, wherein when the computer readable instruction is executed by the processor, the following steps are further implemented:
determining, according to log information, whether the data group or the data subgroups to be actuarially processed that has grouping errors exists; and
if the data group or the data subgroups to be actuarially processed that has grouping errors exists, returning to execute again the step of grouping the target policy data according to a preset product grouping rule to obtain each data group.

21. The actuarial processing method according to claim 2, wherein the actuarial processing method further comprises:
determining, according to log information, whether the data group or the data subgroups to be actuarially processed that has grouping errors exists; and
returning to execute again the step of grouping the target policy data according to a preset product grouping rule to obtain each data group, if the data group or the data subgroups to be actuarially processed that has grouping errors exists.

22. The actuarial processing method according to claim 3, wherein the actuarial processing method further comprises:
determining, according to log information, whether the data group or the data subgroups to be actuarially processed that has grouping errors exists; and
returning to execute again the step of grouping the target policy data according to a preset product grouping rule to obtain each data group, if the data group or the data subgroups to be actuarially processed that has grouping errors exists.

23. The actuarial processing method according to claim 4, wherein the actuarial processing method further comprises:
determining, according to log information, whether the data group or the data subgroups to be actuarially processed that has grouping errors exists; and
returning to execute again the step of grouping the target policy data according to a preset product grouping rule to obtain each data group, if the data group or the data subgroups to be actuarially processed that has grouping errors exists.

24. The actuarial processing method according to claim 5, wherein the actuarial processing method further comprises:
determining, according to log information, whether the data group or the data subgroups to be actuarially processed that has grouping errors exists; and
returning to execute again the step of grouping the target policy data according to a preset product grouping rule to obtain each data group, if the data group or the data subgroups to be actuarially processed that has grouping errors exists.
